(19) United States
(12) Patent Application Publication
(10) Pub. No.: US 2025/0287919 A1
(43) Pub. Date: Sep. 18, 2025

(54) Method, Apparatus and Device for Determining Boundary of Wireless Fence Based on Progressive Distance Triggering

(71) Applicant: Shenzhen Paileji Technology Co., Ltd., Shenzhen (CN)

(72) Inventors: Yunhe DING, Shenzhen (CN); Zhifei ZHANG, Shenzhen (CN)

(21) Appl. No.: 18/918,091

(22) Filed: Oct. 17, 2024

(30) Foreign Application Priority Data
Mar. 15, 2024 (CN) 2024103002479

(51) Int. Cl. A01K 15/02; H04W 4/021

(52) U.S. Cl. CPC A01K 15/023; H04W 4/021

(57) ABSTRACT

The embodiments of the invention relate to the technical field of the internet, and disclose a method for determining the boundary of a wireless fence based on progressive distance triggering. The method comprises: detecting a real-time distance between a target device and a central point of a wireless fence according to a distance detection period, wherein at least two concentric circles are set with the central point of the wireless fence as a center, and each circle denotes a range radius; when the real-time distance is updated, triggering and generating a new device action level, wherein device action levels are in positive correlation with the range radius; determining where there is a current device action that is being performed at present; when there is a current device action that is being performed at present, comparing the new device action level with a current device action level; and when the new device action level is lower than the current device action level, stopping performing the current device action. In this way, multiple progressive distance-based device action levels are set to ensure that a warning can be given more timely and accurately; and the warning can be cancelled when a pet returns, thus reducing discomfort to the pet.

### BACKGROUND OF THE INVENTION

### 1. Technical Field

The embodiments of the invention relate to the technical field of the internet, in particular to a method, apparatus and device for determining the boundary of a wireless fence based on progressive distance triggering, and a computer-readable storage medium.

### 2. Description of Related Art

In the prior art, a tangible fence made from wood, iron or other materials is used for range delineation to prevent pets from leaving a permissible movement range preset by pet owners. With the development of technology, wireless fence products using various approaches such as wireless signal communication and GPS positioning for range delineation and using a receiver for range warning, including, but not limited to, GPS wireless fences, wireless fences provided with a signal transmitter and receiver for wireless signal transmission, wireless fences using a coil buried underground for signal transmission, and wireless fences using a signal transmitter and receiver for wireless communication for distance determination.

However, the inventor of the application finds that on the one hand, existing wireless fence techniques give a warning after a pet leaves the boundary of a fence, so the warning is startling and the level of the warning cannot be increased or decreased or the warning cannot be started or stopped according to the moving direction of the pet, and the warning is misadvised to certain extent; and on the other hand, when the pet is located outside a wireless fence, the existing wireless fence techniques obtain the direction of the pet by means of sensors and increase or decrease of the level of the warning according to the direction of the pet, leading to a high false rate of the increase or decrease of the level of the warning because there is not an absolute relation between the direction and movement of the pet.

### BRIEF SUMMARY OF THE INVENTION

In view of the above problems, the embodiments of the invention provide a method, apparatus and device for determining the boundary of a wireless fence based on progressive distance triggering and a computer-readable storage medium to solve the problems that there is neither a method for giving a warning within the boundary of a fence nor a method for updating, degrading, starting and stopping a warning according to the movement direction of a pet in the prior art.

In one aspect, the embodiments of the invention provide a method for determining the boundary of a wireless fence based on progressive distance triggering, comprising:

a step of detecting a real-time distance between a target device and a central point of a wireless fence according to a distance detection period, wherein at least two concentric circles are set with the central point of the wireless fence as a center, and each circle denotes a range radius;

a step of triggering and generating a new device action level when the real-time distance is updated, wherein the new device action level corresponds to the range radius; one device action level is set between a minimum range radius and the central point, one device action level is set between every two adjacent range radii, and one device action level is set beyond a maximum range radius; the device action levels are in positive correlation with the range radius;

a step of determining where there is a current device action that is being performed at present, wherein the current device action corresponds to a current device action level, and one device action level corresponds to one device action;

a step of comparing the new device action level with the current device action level when there is a current device action that is being performed at present; and

a step of stopping performing the current device action, not performing a new action and marking the current device action level as the new device action level when the new device action level is lower than the current device action level.

Optionally, the step of comparing the new device action level with the current device action level when there is a current device action that is being performed at present further comprises:

when the new device action level is higher than the current device action level, performing a device action corresponding to the new device action level, and marking the current device action level as the new device action level; or

when the new device action level is equal to the current device action level, waiting until the current device action is completed.

Optionally, the step of determining where there is a current device action that is being performed at present further comprises:

when there is not a current device action that is being performed at present, comparing the new device action level with the current device action level;

when the new device action level is higher than or equal to the current device action level, performing a device action corresponding to the new device action level, and marking the current device action level as the new device action level; or

when the new device action level is lower than the current device action level, not performing the device action corresponding to the new device action level, and marking the current device action level as the new device action level.

Optionally, before the step of detecting a real-time distance between a target device and a central point of a wireless fence according to a distance detection period, the method further comprises:

a step of setting an intensity level of the device action level, wherein an intensity of the device action corresponding to the device action level is in positive correlation with the intensity level of the device action level;

a step of setting a device action level, the intensity level of which is in positive correlation with the range radius, between the maximum range radius and the central point; and

a step of setting a device action level, the intensity levels of which is preset, beyond the maximum range radius, wherein the preset intensity level is lower than a maximum intensity level of the device action level.

Optionally, before the step of detecting a real-time distance between a target device and a central point of a wireless fence according to a distance detection period, the method further comprises:

a step of setting positional information of the central point and a range radius of the wireless fence, wherein the range radius of the wireless fence is identical with the range radius of one circle.

Optionally, the device actions corresponding to the device action levels comprise no action, a sound warning, a sound and vibration warning, and a sound, vibration and current warning in a descending order of the intensity level, and the step of setting a device action level, the intensity level of which is preset, beyond the maximum range radius comprises:

setting the device action level, the intensity level of which is preset, beyond the maximum range radius, wherein a device action corresponding to the preset intensity level is the sound warning.

Optionally, the step of detecting a real-time distance between a target device and a central point of a wireless fence according to a distance detection period comprises:

acquiring a real-time position of the target device according to the distance detection period, and calculating the real-time distance between the target device and the central point according to the real-time position and positional information of the central point;

or,

acquiring communication information between the target device and the central point according to the distance detection period, and calculating the real-time distance between the target device and the central point according to the communication information.

In another aspect, the embodiments of the invention provide an apparatus for determining the boundary of a wireless fence based on progressive distance triggering, comprising:

a distance detection module used for detecting a real-time distance between a target device and a central point of a wireless fence according to a distance detection period, wherein at least two concentric circles are set with the central point of the wireless fence as a center, and each circle denotes a range radius;

an action level updating module used for triggering and generating a new device action level when the real-time distance is updated, wherein the new device action level corresponds to the range radius; one device action level is set between a minimum range radius and the central point, one device action level is set between every two adjacent range radii, and one device action level is set beyond a maximum range radius; the device action levels are in positive correlation with the range radius;

a state determination module used for determining where there is a current device action that is being performed at present, wherein the current device action corresponds to a current device action level, and one device action level corresponds to one device action; and

an action performing module used for comparing the new device action level with the current device action level when there is a current device action that is being performed at present, and stopping performing the current device action, not performing a new action and marking the current device action level as the new device action level when the new device action level is lower than the current device action level.

In another aspect, the embodiments of the invention provide a wireless fence, comprising a processor, a memory, a communication interface and a communication bus, wherein the processor, the memory and the communication interface communicate with each other by means of the communication bus;

the memory is used for storing at least one executable instruction, and the executable instruction instructs the processor to perform operations of the method for determining the boundary of a wireless fence based on progressive distance triggering according to any one of the above embodiments.

In another aspect, the embodiments of the invention provide a computer-readable storage medium, wherein at least one executable instruction is stored in the storage medium, and when the executable instruction runs on a device for determining the boundary of a wireless fence based on progressive distance triggering, the device for determining the boundary of a wireless fence based on progressive distance triggering implements operations of the method for determining the boundary of a wireless fence based on progressive distance triggering according to any one of the above embodiments.

According to the embodiments of the invention, when the distance between the target device and the central point is updated, a new device action level is triggered and generated, the device action level is constrained and logically determined, and when the priority of the new device action level is lower than the priority of the current device action level, the target device stops performing the current device action, such that the device action can be cancelled when the target device moves towards the central point, thus reducing discomfort to a target and improving the target constraint capacity of the wireless fence.

The technical solutions of the embodiments of the invention are summarized above, and to allows those skilled in the art to gain a better understanding of the technical solutions of the embodiments of the invention so as to implement the invention according to the contents in the description and to make the above and other purposes, features and advantages of the embodiments of the invention better understood, the following specific embodiments are provided.

### BRIEF DESCRIPTION OF THE SEVERAL VIEWS OF THE DRAWINGS

The drawings are merely used for illustrating embodiments of the invention and should not be construed as limitations of the invention. In the drawings, identical reference signs indicate identical components. In the drawings:

FIG. 1 illustrates a flow diagram of a method for determining the boundary of a wireless fence based on progressive distance triggering according to one embodiment of the invention;

FIG. 2 illustrates a structural diagram of an apparatus for determining the boundary of a wireless fence based on progressive distance triggering according to one embodiment of the invention;

FIG. 3 illustrates a structural diagram of a wireless fence based on progressive distance triggering according to one embodiment of the invention;

### DETAILED DESCRIPTION OF THE INVENTION

Illustrative embodiments of the invention are described in further detail below with reference to the accompanying drawings. Although illustrative embodiments of the invention are shown in the accompanying drawings, it should be understood that the invention can be implemented in various forms and should not be limited by the embodiments expounded here.

It should be noted that although existing wireless fence techniques can give a high-intensity warning when a wearer wearing a target device (a pet) leaves the boundary of a wireless fence to constrain the movement area of the pet, they cannot increase or decrease the level of the warning or start or stop the warning according to the movement direction of the pet, and when the pet moves towards a central point, the warning cannot be stopped or the level of the warning cannot be increased or decreased reasonably, so the warning is misadvised to certain extent, and the pet may be hurt easily. In addition, the existing techniques increase or decrease the level of the warning according to the direction of the pet when the pet is located outside the wireless fence; however, the applicant finds that the increase or decrease of the level of the warning in such as method has a high false rate because there is not an absolute relation between the direction and movement of the pet. In view of this, in the application, the movement direction of a pet is acquired, and the level of a warning is increased or decreased or a warning is started or stopped based on progressive distance triggering for a wireless fence for pets, such that the warning of the pet will not be misadvised.

### Embodiment

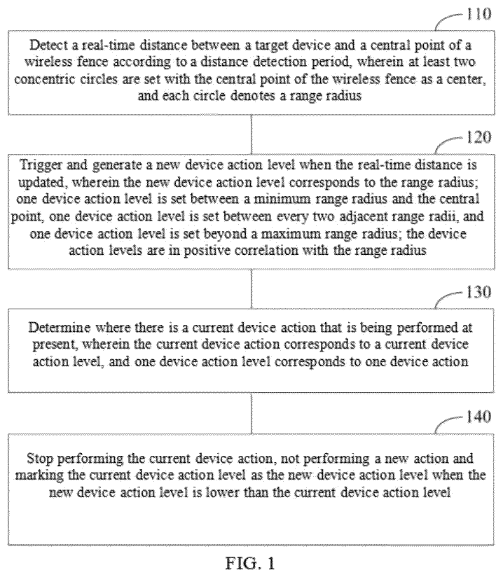

FIG. 1 illustrates a flow diagram of a method for determining the boundary of a wireless fence based on progressive distance triggering according to one embodiment of the invention, the method is implemented by a wireless fence, which may be a wireless fence product worn by a target, and the target is generally a pet; and correspondingly, the wireless fence product may be in the form of a necklace or a wristband. As shown in FIG. 1, the method comprises the following steps:

Step 110: detecting a real-time distance between a target device and a central point of a wireless fence according to a distance detection period, wherein at least two concentric circles are set with the central point of the wireless fence as a center, and each circle denotes a range radius.

In another embodiment of the invention, the circular may also be denoted by a range diameter.

Wherein, before Step 110, the method further comprises: setting positional information of the central point and a range radius of the wireless fence, wherein the range radius of the wireless fence is identical with the range radius of one of the at least two circles.

Wherein, the positional information of the central point may be geographical coordinates set manually or coordinates of an existing base station in a map; the range radius R of the wireless fence may be set manually, and the range delineated by the range radius R of the wireless fence is an original boundary of the wireless fence.

In another embodiment of the invention, the wireless fence may be denoted by a range diameter.

Wherein, at least two concentric circles are set with the central point of the wireless fence as the center. Specifically, the number and data of the at least two concentric circles may be set manually. For example, the at least two concentric circles at named r1, r2, r3, . . . , and rx in an ascending order of the range radius, and rx is the concentric circle with a maximum range radius; and the concentric circles form multiple boundaries which are triggered progressively according to the distance with the central point as the center.

Wherein, the range radius of the wireless fence is identical with the range radius of one circle. Specifically, the range radius R of the wireless fence is set to be identical with the range radius of the circle larger than r1, that is, R=r2, r3, . . . , or rx. That is, in this embodiment of the invention, circles with progressive distances are delineated around the wireless fence based on the original boundary of the original wireless fence.

In this embodiment of the invention, at least two concentric circles are set with the central point of the wireless fence as the center, the radius of the smallest concentric circle r1 is less than the range radius R of the wireless fence, and the radius of one concentric circle is set to be identical with the range radius of the wireless fence, such that multiple boundaries with progressive distances can be set around the wireless fence for trigger determination under the condition of reserving original boundary determination of the wireless fence, thus ensuring that a warning can be given more timely and accurately before a pet leaves the boundary of the wireless fence.

Wherein, the step of detecting a real-time distance between a target device and a central point of a wireless fence according to a distance detection period comprises: acquiring a real-time position of the target device according to the distance detection period, and calculating the real-time distance between the target device and the central point according to the real-time position and positional information of the central point; or, acquiring communication information between the target device and the central point according to the distance detection period, and calculating the real-time distance between the target device and the central point according to the communication information.

Wherein, the real-time position of the target device is acquired according to the distance detection period, and the real-time distance between the target device and the central point is calculated according to the real-time position and positional information of the central point. Specifically, the target device may be equipped with a GPS, the central point may be recorded by software, and longitude and latitude information is marked as the central point D0; and according to the distance detection period, the real-time position comprising the longitude and latitude information of the target device is acquired by the GPS, and the real-time distance between the target device and the central point is calculated according to the real-time position and the positional information of the central point D0.

Wherein, the communication information between the target device and the central point is acquired according to the distance detection period, and the real-time distance between the target device and the central point is calculated according to the communication information. Specifically, the central point D0 is determined based on the position of an existing base station, and the target device establishes a communication with the base station of the central point D0; and the communication information between the target device and the central point is acquired according to the distance detection period, and the real-time distance between the target device and the central point is calculated according to the communication information by a time of flight (TOF), a time difference of arrival (TDOA), or other methods. The embodiments of the invention have no limitation to the specific distance detection method.

Step 120: a step of triggering and generating a new device action level when the real-time distance is updated, wherein the new device action level corresponds to the range radius; one device action level is set between a minimum range radius and the central point, one device action level is set between every two adjacent range radii, and one device action level is set beyond a maximum range radius; the device action levels are in positive correlation with the range radius.

Wherein, the update period of the real-time distance may be set according to the actual performance of the target device.

Wherein, when the real-time distance Rx is updated, the device action level of the target device is determined according to positional relations between the real-time distance Rx and the range radii of the circles. Specifically, when Rx<r1, the device action level is a lowest level L1, and a corresponding device action is V1; when r1<Rx<r, the device action level is L2, and a corresponding device action is V2; when r2<Rx<r3, the device action level is L3, and a corresponding device action is V3; when Rx>rx, the device action level is L(x+1), and a corresponding device action is V(x+1).

Wherein, the device action levels are in positive correlation with the range radius. Specifically, L1<L2<L3 < . . . <Lx<L(x+1).

Wherein, there may be multiple levels between the new device action level and a current device action level. For example, the current device action level is V1, and the new device action level is V3 or higher.

Step 130: determining where there is a current device action that is being performed at present, wherein the current device action corresponds to the current device action level, and one device action level corresponds to one device action.

In this embodiment of the invention, because the device action of the target device may last for a time longer than the update time of the real-time distance Rx, the current device action level may need to be updated into the new device action level when the target device performs the current device action. In view of this, device actions on different levels need to be constrained and logically determined according to whether the target device is performing a current device action.

Wherein, the current device action level is a device action level corresponding to the target device before the real-time distance Rx is updated.

In this embodiment of the invention, multiple device action levels are set according to the range radii of the circles, such that different warning schemes can be executed according to the distance, thus improving warning effectiveness.

Step 140: when there is a current device action that is being performed at present, comparing the new device action level with the current device action level; and when the new device action level is lower than the current device action level, stopping performing the current device action, and not performing a new action and marking the current device action level as the new device action level.

Wherein, Step 140 further comprises: when the new device action level is higher than the current device action level, performing a device action corresponding to the new device action level, and marking the current device action level as the new device action level; or, when the new device action level is equal to the current device action level, waiting until the current device action is completed.

Wherein, Step 140 further comprises: when there is not a current device action that is being performed at present, comparing the new device action level with the current device action level; when the new device action level is higher than or equal to the current device action level, performing a device action corresponding to the new device action level, and marking the current device action level as the new device action level; or, when the new device action level is lower than the current device action level, not performing the device action corresponding to the new device action level, and marking the current device action level as the new device action level.

In this embodiment of the invention, different device action levels are set according to the distance, and the priority of the device action levels is constrained and logically determined; when the new device action level is higher than the current device action level, a new action is performed instantly; when the new device action level is equal to the current device action level, the current action continues to be performed until it is completed; and when the new device action level is lower than the current device action level, the current action level is stopped instantly. In this way, the device action can be stopped instantly or the new device action will not be performed when the target device moves towards the central point, such that a warning can be cancelled instantly when a pet returns, thus reducing discomfort to the pet and better guiding and constraining the pet.

Wherein, before Step 110, the method further comprises: setting an intensity level of the device action level, wherein an intensity of the device action corresponding to the device action level is in positive correlation with the intensity level of the device action level; setting a device action level, the intensity level of which is in positive correlation with the range radius, between the maximum range radius and the central point; and setting a device action level, the intensity levels of which is preset, beyond the maximum range radius, wherein the preset intensity level is lower than a maximum intensity level of the device action level.

Wherein, the device action level, the intensity level of which is in positive correlation with the range radius, is set between the maximum range radius and the central point, specifically, V1<V2<V3< . . . <Vx.

Wherein, the device action level, the intensity levels of which is preset, is set beyond the maximum range radius, wherein the preset intensity level is lower than the maximum intensity level of the device action level. Specifically, V(x+1)<Vx.

Wherein, the device actions corresponding to the device action levels comprise no action, a sound warning, a sound and vibration warning, and a sound, vibration and current warning in a descending order of the intensity level, and the step of setting a device action level, the intensity level of which is preset, beyond the maximum range radius comprises: setting the device action level, the intensity level of which is preset, beyond the maximum range radius, wherein a device action corresponding to the preset intensity level is the sound warning.

Wherein, the device actions corresponding to the device action levels can be adjusted according to actual circumstances. For example, in other embodiments of the invention, water warning, light warning and other device actions may be added, or the device actions may be deleted.

Wherein, the sound warning comprises music, or other recorded noisy or buzzing warnings.

The device action level, the intensity level of which is preset, is set beyond the maximum range radius, wherein the device action corresponding to the preset intensity level is the sound warning, and the sound warning is preferably the buzzing warning.

In this embodiment of the invention, device action levels with different intensity levels are set within and beyond the maximum range radius, such that a high-intensity warning of a target can be stopped when the target device returns into the maximum range radius, and only the sound warning is reversed around, thus reducing unnecessary discomfort to a pet, facilitating the retrieval of the pet and reducing the possibility that the pet is kidnapped.

Optionally, the target device is also used for establishing a communication with a user device, and the user device communicates with the target device to obtain the positional information and operating state of the target device.

### Embodiment

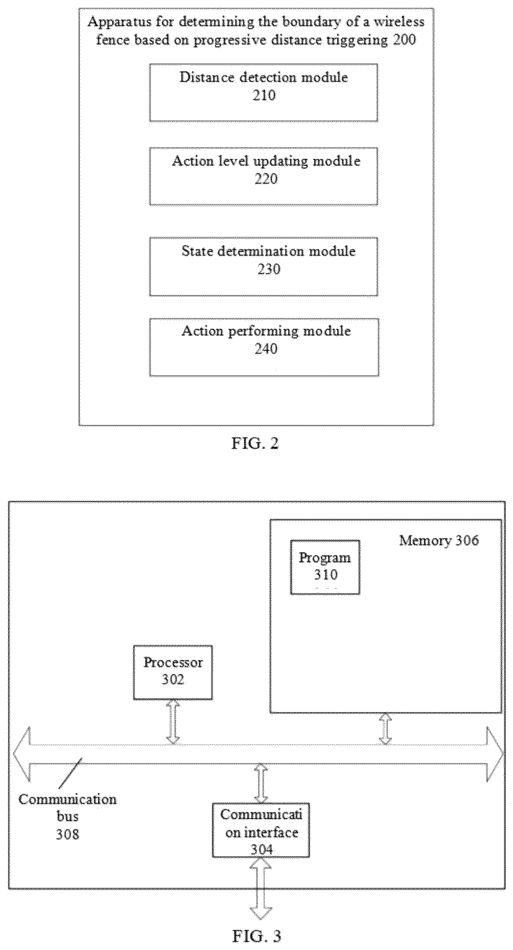

FIG. 2 illustrates a structural diagram of an apparatus for determining the boundary of a wireless fence based on progressive distance triggering according to one embodiment of the invention. As shown in FIG. 2, the apparatus 200 for determining the boundary of a wireless fence based on progressive distance triggering comprises: a distance detection module 210, an action level updating module 220, a state determination module 230 and an action performing module 240.

Wherein, the distance detection module 210 is used for detecting a real-time distance between a target device and a central point of a wireless fence according to a distance detection period, wherein at least two concentric circles with the central point of the wireless fence as a center are set, and each circle denotes a range radius.

In one embodiment of the invention, the distance detection module 210 comprises a positioning unit and a calculation unit, wherein the positioning unit is used for acquiring positional information of the target device according to the distance detection period, and the calculation unit is used for calculating the real-time distance between the target device and the central point of the wireless fence according to the positional information of the target device provided by the positioning unit and positional information of the central point.

In another embodiment of the invention, the distance detection module 210 comprises a communication unit and a calculation unit, wherein the communication unit is used for acquiring communication information between the target device and the central point according to the distance detection period, and the calculation unit is used for calculating the real-time distance between the target device and the central point according to the communication information.

Wherein, the action level updating module 220 is used for triggering and generating a new device action level when the real-time distance is updated, wherein the new device action level corresponds to the range radius; one device action level is set between a minimum range radius and the central point, one device action level is set between every two adjacent range radii, and one device action level is set beyond a maximum range radius; and the device action levels are in positive correlation with the range radius.

Wherein, the state determination module 230 used for determining where there is a current device action that is being performed at present, wherein the current device action corresponds to a current device action level, and one device action level corresponds to one device action.

Wherein, the action performing module 240 used for comparing the new device action level with the current device action level when there is a current device action that is being performed at present, and stopping performing the current device action, not performing a new action and marking the current device action level as the new device action level when the new device action level is lower than the current device action level.

Optionally, the action performing module 240 is also used for comparing the new device action level with the current device action level when there is a current device action that is being performed at present, performing a device action corresponding to the new device action level and marking the current device action level as the new device action level when the new device action level is higher than the current device action level, and waiting until the current device action is completed when the new device action level is equal to the current device action level.

Optionally, the action performing module 240 is also used for comparing the new device action level with the current device action level when there is not a current device action that is being performed at present, performing a device action corresponding to the new device action level and marking the current device action level as the new device action level when the new device action level is higher than or equal to the current device action level, and not performing the device action corresponding to the new device action level and marking the current device action level as the new device action level when the new device action level is lower than the current device action level.

Optionally, before the step of detecting a real-time distance between a target device and a central point of a wireless fence according to a distance detection period, the method further comprises: a step of setting an intensity level of the device action level, wherein an intensity of the device action corresponding to the device action level is in positive correlation with the intensity level of the device action level; a step of setting a device action level, the intensity level of which is in positive correlation with the range radius, between the maximum range radius and the central point; and a step of setting a device action level, the intensity levels of which is preset, beyond the maximum range radius, wherein the preset intensity level is lower than a maximum intensity level of the device action level.

Optionally, before the step of detecting a real-time distance between a target device and a central point of a wireless fence according to a distance detection period, the method further comprises: a step of setting positional information of the central point and a range radius of the wireless fence, wherein the range radius of the wireless fence is identical with the range radius of one circle.

Optionally, the device actions corresponding to the device action levels comprise no action, the sound warning, the sound and vibration warning, and the sound, vibration and current warning in the descending order of the intensity level, and the step of setting a device action level, the intensity level of which is preset, beyond the maximum range radius comprises: setting the device action level, the intensity level of which is preset, beyond the maximum range radius, wherein a device action corresponding to the preset intensity level is the sound warning.

According to this embodiment of the invention, when the distance between the target device and the central point is updated, a new device action level is triggered and generated, the device action level is constrained and logically determined, and when the priority of the new device action level is lower than the priority of the current device action level, the target device stops performing the current device action, such that the device action can be cancelled when the target device moves towards the central point, thus reducing discomfort to a target and improving the target constraint capacity of the wireless fence.

### Embodiment

FIG. 3 illustrates a structural diagram of a wireless fence based on progressive distance triggering according to one embodiment of the invention. The wireless fence in this embodiment of the invention may be any wireless fence products GPS wireless fences, wireless fences provided with a signal transmitter and receiver for wireless signal transmission, wireless fences using a coil buried underground for signal transmission, and wireless fences using a signal transmitter and receiver for wireless communication for distance determination. The specific embodiments of the invention have no limitation to the specific implementations of the wireless fence.

As shown in FIG. 3, the wireless fence may comprise: a processor 302, a communication interface 304, a memory 306 and a communication bus 308.

Wherein, the processor 302, the communication interface 304 and the memory 306 communicate with each other by means of the communication bus 308. The communication interface 304 is used for communicating with network elements of other devices such as clients or other servers. The processor 302 is used for executing a program 310 and specifically can perform related steps in the embodiment of the method for determining the boundary of a wireless fence based on progressive distance triggering described above.

Specifically, the program 310 may comprise a program code, and the program code comprises a computer-readable instruction.

The processor 302 may be a central processing unit (CPU) or an application specific integrated circuit (ASIC), or may be configured as one or more integrated circuits for implementing the embodiments of the invention. An apparatus for determining the boundary of a wireless fence based on progressive distance triggering comprises one or more processors, wherein the processors may be of the same type, such as one or more CPUs; the processors may also be of different types, such as one or more CPUs and one or more ASICs.

The memory 306 is used for storing the program 310. The memory 306 may comprise a high-speed RAM or comprise a non-volatile memory such as at least one disk memory.

The program 310 may be specifically invoked by the processor 302 to perform the following operations:

detecting a real-time distance between a target device and a central point of a wireless fence according to a distance detection period, wherein at least two concentric circles are set with the central point of the wireless fence as a center, and each circle denotes a range radius;

triggering and generating a new device action level when the real-time distance is updated, wherein the new device action level corresponds to the range radius; one device action level is set between a minimum range radius and the central point, one device action level is set between every two adjacent range radii, and one device action level is set beyond a maximum range radius; the device action levels are in positive correlation with the range radius;

determining where there is a current device action that is being performed at present, wherein the current device action corresponds to a current device action level, and one device action level corresponds to one device action;

comparing the new device action level with the current device action level when there is a current device action that is being performed at present; and stopping performing the current device action, not performing a new action and marking the current device action level as the new device action level when the new device action level is lower than the current device action level.

Optionally, the operation of comparing the new device action level with the current device action level when there is a current device action that is being performed at present further comprises: when the new device action level is higher than the current device action level, performing a device action corresponding to the new device action level, and marking the current device action level as the new device action level; or, when the new device action level is equal to the current device action level, waiting until the current device action is completed.

Optionally, the operation of determining where there is a current device action that is being performed at present further comprises: when there is not a current device action that is being performed at present, comparing the new device action level with the current device action level; when the new device action level is higher than or equal to the current device action level, performing a device action corresponding to the new device action level, and marking the current device action level as the new device action level; or, when the new device action level is lower than the current device action level, not performing the device action corresponding to the new device action level, and marking the current device action level as the new device action level.

Optionally, before the operation of detecting a real-time distance between a target device and a central point of a wireless fence according to a distance detection period, the method further comprises: an operation of setting an intensity level of the device action level, wherein an intensity of the device action corresponding to the device action level is in positive correlation with the intensity level of the device action level; an operation of setting a device action level, the intensity level of which is in positive correlation with the range radius, between the maximum range radius and the central point; and an operation of setting a device action level, the intensity levels of which is preset, beyond the maximum range radius, wherein the preset intensity level is lower than a maximum intensity level of the device action level.

Optionally, before the operation of detecting a real-time distance between a target device and a central point of a wireless fence according to a distance detection period, the method further comprises: an operation of setting positional information of the central point and a range radius of the wireless fence, wherein the range radius of the wireless fence is identical with the range radius of one circle.

Optionally, the device actions corresponding to the device action levels comprise no action, a sound warning, a sound and vibration warning, and a sound, vibration and current warning in a descending order of the intensity level, and the operation of setting a device action level, the intensity level of which is preset, beyond the maximum range radius comprises: setting the device action level, the intensity level of which is preset, beyond the maximum range radius, wherein a device action corresponding to the preset intensity level is the sound warning.

Optionally, the operation of detecting a real-time distance between a target device and a central point of a wireless fence according to a distance detection period comprises: acquiring a real-time position of the target device according to the distance detection period, and calculating the real-time distance between the target device and the central point according to the real-time position and positional information of the central point; or, acquiring communication information between the target device and the central point according to the distance detection period, and calculating the real-time distance between the target device and the central point according to the communication information.

According to this embodiment of the invention, when the distance between the target device and the central point is updated, a new device action level is triggered and generated, the device action level is constrained and logically determined, and when the priority of the new device action level is lower than the priority of the current device action level, the target device stops performing the current device action, such that the device action can be cancelled when the target device moves towards the central point, thus reducing discomfort to a target and improving the target constraint capacity of the wireless fence.

### Embodiment

One embodiment of the invention provides a computer-readable storage medium, wherein the storage medium stores at least one executable instruction, and when the executable instruction runs on an apparatus for determining the boundary of a wireless fence based on progressive distance triggering, the apparatus for determining the boundary of a wireless fence based on progressive distance triggering implements the method for determining the boundary of a wireless fence based on progressive distance triggering according to any one of the above embodiments.

The executable instruction may be specifically used for enabling the apparatus for determining the boundary of a wireless fence based on progressive distance triggering to perform the following operations:

detecting a real-time distance between a target device and a central point of a wireless fence according to a distance detection period, wherein at least two concentric circles are set with the central point of the wireless fence as a center, and each circle denotes a range radius;

triggering and generating a new device action level when the real-time distance is updated, wherein the new device action level corresponds to the range radius; one device action level is set between a minimum range radius and the central point, one device action level is set between every two adjacent range radii, and one device action level is set beyond a maximum range radius; the device action levels are in positive correlation with the range radius;

determining where there is a current device action that is being performed at present, wherein the current device action corresponds to a current device action level, and one device action level corresponds to one device action;

comparing the new device action level with the current device action level when there is a current device action that is being performed at present; and

stopping performing the current device action, not performing a new action and marking the current device action level as the new device action level when the new device action level is lower than the current device action level.

Optionally, the operation of comparing the new device action level with the current device action level when there is a current device action that is being performed at present further comprises: when the new device action level is higher than the current device action level, performing a device action corresponding to the new device action level, and marking the current device action level as the new device action level; or, when the new device action level is equal to the current device action level, waiting until the current device action is completed.

Optionally, the operation of determining where there is a current device action that is being performed at present further comprises: when there is not a current device action that is being performed at present, comparing the new device action level with the current device action level; when the new device action level is higher than or equal to the current device action level, performing a device action corresponding to the new device action level, and marking the current device action level as the new device action level; or, when the new device action level is lower than the current device action level, not performing the device action corresponding to the new device action level, and marking the current device action level as the new device action level.

Optionally, before the operation of detecting a real-time distance between a target device and a central point of a wireless fence according to a distance detection period, the method further comprises: an operation of setting an intensity level of the device action level, wherein an intensity of the device action corresponding to the device action level is in positive correlation with the intensity level of the device action level; an operation of setting a device action level, the intensity level of which is in positive correlation with the range radius, between the maximum range radius and the central point; and an operation of setting a device action level, the intensity levels of which is preset, beyond the maximum range radius, wherein the preset intensity level is lower than a maximum intensity level of the device action level.

Optionally, before the operation of detecting a real-time distance between a target device and a central point of a wireless fence according to a distance detection period, the method further comprises: an operation of setting positional information of the central point and a range radius of the wireless fence, wherein the range radius of the wireless fence is identical with the range radius of one circle.

Optionally, the device actions corresponding to the device action levels comprise no action, a sound warning, a sound and vibration warning, and a sound, vibration and current warning in a descending order of the intensity level, and the operation of setting a device action level, the intensity level of which is preset, beyond the maximum range radius comprises: setting the device action level, the intensity level of which is preset, beyond the maximum range radius, wherein a device action corresponding to the preset intensity level is the sound warning.

Optionally, the operation of detecting a real-time distance between a target device and a central point of a wireless fence according to a distance detection period comprises: acquiring a real-time position of the target device according to the distance detection period, and calculating the real-time distance between the target device and the central point according to the real-time position and positional information of the central point; or, acquiring communication information between the target device and the central point according to the distance detection period, and calculating the real-time distance between the target device and the central point according to the communication information.

According to this embodiment of the invention, when the distance between the target device and the central point is updated, a new device action level is triggered and generated, the device action level is constrained and logically determined, and when the priority of the new device action level is lower than the priority of the current device action level, the target device stops performing the current device action, such that the device action can be cancelled when the target device moves towards the central point, thus reducing discomfort to a target and improving the target constraint capacity of the wireless fence.

According to this embodiment of the invention, when the distance between the target device and the central point is updated, a new device action level is triggered and generated, the device action level is constrained and logically determined, and when the priority of the new device action level is lower than the priority of the current device action level, the target device stops performing the current device action, such that the device action can be cancelled when the target device moves towards the central point, thus reducing discomfort to a target and improving the target constraint capacity of the wireless fence.

One embodiment of the invention provides a device for determining the boundary of a wireless fence based on progressive distance triggering provided by the invention, which is used for implementing the method for determining the boundary of a wireless fence based on progressive distance triggering described above.

One embodiment of the invention provides a computer program, wherein when the computer program may be invoked by a processor to implement the method for determining the boundary of a wireless fence based on progressive distance triggering according to any one of the above embodiments.

One embodiment of the invention provides a computer program product, wherein the computer program product comprises a computer program stored in a computer-readable storage medium, the computer program comprises a program instruction, and when the program instruction runs on a computer, the computer is instructed to implement the method for determining the boundary of a wireless fence based on progressive distance triggering according to any one of the above embodiments.

The algorithm or display provided where is not inherently related to any specific computers, virtual systems or other devices. Various general-purpose system may be used together with the teachings provided here. With reference to the above description, it is obvious to construct structures required by such systems. In addition, the embodiments of the invention do not aim at any specific programming language. It should be understood that the contents of the invention described here may be implemented in various programming languages, and the description of the above specific language is used for disclosing preferred embodiments of the invention.

A large number of details are provided here. However, it should be understood that the embodiments of the invention may be implemented without these specific details. In some embodiments, commonly known methods, structures and techniques are not detailed to ensure a clear understanding of the invention.

Similarly, it should be understood that for the sake of brevity and a good understanding of one or more aspects of the invention, the features in the illustrative embodiments of the invention described above may be sometimes combined in one embodiment, drawing or description thereof. The method of the disclosure should not be interpreted as the following intention: the invention claiming for protection is required to have more features than those clearly recorded in the claims.

Those skilled in the art should understand that modules in the embodiments of the invention can be adaptively changed and arranged in one or more devices different from the device in this embodiment. The modules, units or assemblies in the embodiments may be combined into one module, unit or assembly, or may be divided into multiple sub-modules, sub-units or sub-assemblies. Except at least some features and/or processes or units that are mutually exclusive, all features disclosed here (in the claims, abstract and drawings attached) may be implemented by any combinations or all processes or units of any method or device disclosed here may be combined. Unless otherwise expressly stated, each feature disclosed here (in the claims, abstract and drawings attached) may be replaced with an identical, equivalent or similar alternative feature.

It should be noted that the above embodiments are used for explaining the invention rather than limiting the invention, and those skilled in the art can design alternative embodiments without departing from the scope of the claims. In the claims, any reference marks between brackets should not be construed as limitations of the invention. The term “comprise” shall not exclude elements or steps that are not listed in the claims. Terms “a/an” or “one” before an element shall not exclude the presence of multiple said elements. The invention may be implemented by means of hardware comprising a plurality of different elements or by means of a proper programming computer. In a claim listing a plurality of devices, the plurality of devices may be implemented by means of a same hardware item. Terms “first”, “second” and “third” do not indicate any sequences and may be interpreted as names. Unless otherwise specially stated, steps in the above embodiments of the invention should not be understood as the definition of a sequence.

What is claimed is:

1. A method for determining the boundary of a wireless fence based on progressive distance triggering, wherein the method is applied to a wireless fence product for a pet and comprises:
a step of detecting a real-time distance between a target device and a central point of a wireless fence according to a distance detection period, wherein at least two concentric circles are set with the central point of the wireless fence as a center, and each circle denotes a range radius;
a step of triggering and generating a new device action level when the real-time distance is updated, wherein the new device action level corresponds to the range radius; one device action level is set between a minimum range radius and the central point, one device action level is set between every two adjacent range radii, and one device action level is set beyond a maximum range radius; the device action levels are in positive correlation with the range radius;
a step of determining where there is a current device action that is being performed at present, wherein the current device action corresponds to a current device action level, and one device action level corresponds to one device action; the device actions corresponding to the device action levels comprise no action, a sound warning, a sound and vibration warning, and a sound, vibration and current warning in a descending order of an intensity level;
a step of comparing the new device action level with the current device action level when there is a current device action that is being performed at present; and
a step of stopping performing the current device action, not performing a new action and marking the current device action level as the new device action level when the new device action level is lower than the current device action level.

2. The method according to claim 1, wherein the step of comparing the new device action level with the current device action level when there is a current device action that is being performed at present further comprises:
when the new device action level is higher than the current device action level, performing a device action corresponding to the new device action level, and marking the current device action level as the new device action level; or
when the new device action level is equal to the current device action level, waiting until the current device action is completed.

3. The method according to claim 1, wherein the step of determining where there is a current device action that is being performed at present further comprises:
when there is not a current device action that is being performed at present, comparing the new device action level with the current device action level;
when the new device action level is higher than or equal to the current device action level, performing a device action corresponding to the new device action level, and marking the current device action level as the new device action level; or
when the new device action level is lower than the current device action level, not performing the device action corresponding to the new device action level, and marking the current device action level as the new device action level.

4. The method according to claim 1, wherein before the step of detecting a real-time distance between a target device and a central point of a wireless fence according to a distance detection period, the method further comprises:
a step of setting an intensity level of the device action level, wherein an intensity of the device action corresponding to the device action level is in positive correlation with the intensity level of the device action level;
a step of setting a device action level, the intensity level of which is in positive correlation with the range radius, between the maximum range radius and the central point; and
a step of setting a device action level, the intensity levels of which is preset, beyond the maximum range radius, wherein the preset intensity level is lower than a maximum intensity level of the device action level.

5. The method according to claim 1, wherein before the step of detecting a real-time distance between a target device and a central point of a wireless fence according to a distance detection period, the method further comprises:
a step of setting positional information of the central point and a range radius of the wireless fence, wherein the range radius of the wireless fence is identical with the range radius of one said circle.

6. The method according to claim 4, wherein the device actions corresponding to the device action levels comprise no action, the sound warning, the sound and vibration warning, and the sound, vibration and current warning in the descending order of the intensity level, and the step of setting a device action level, the intensity level of which is preset, beyond the maximum range radius comprises:
setting the device action level, the intensity level of which is preset, beyond the maximum range radius, wherein a device action corresponding to the preset intensity level is the sound warning.

7. The method according to claim 1, wherein the step of detecting a real-time distance between a target device and a central point of a wireless fence according to a distance detection period comprises:
acquiring a real-time position of the target device according to the distance detection period, and calculating the real-time distance between the target device and the central point according to the real-time position and positional information of the central point;
or,
acquiring communication information between the target device and the central point according to the distance detection period, and calculating the real-time distance between the target device and the central point according to the communication information.

8. An apparatus for determining the boundary of a wireless fence based on progressive distance triggering, wherein the apparatus is a wireless fence product for a pet and comprises:
a distance detection module used for detecting a real-time distance between a target device and a central point of a wireless fence according to a distance detection period, wherein at least two concentric circles are set with the central point of the wireless fence as a center, and each circle denotes a range radius;
an action level updating module used for triggering and generating a new device action level when the real-time distance is updated, wherein the new device action level corresponds to the range radius; one device action level is set between a minimum range radius and the central point, one device action level is set between every two adjacent range radii, and one device action level is set beyond a maximum range radius; the device action levels are in positive correlation with the range radius;
a state determination module used for determining where there is a current device action that is being performed at present, wherein the current device action corresponds to a current device action level, and one device action level corresponds to one device action; the device actions corresponding to the device action levels comprise no action, a sound warning, a sound and vibration warning, and a sound, vibration and current warning in a descending order of an intensity level; and
an action performing module used for comparing the new device action level with the current device action level when there is a current device action that is being performed at present, and stopping performing the current device action, not performing a new action and marking the current device action level as the new device action level when the new device action level is lower than the current device action level.

9. A wireless fence, comprising a processor, a memory, a communication interface and a communication bus, wherein the processor, the memory and the communication interface communicate with each other by means of the communication bus;
the memory is used for storing at least one executable instruction, and the executable instruction instructs the processor to perform operations of the method for determining the boundary of a wireless fence based on progressive distance triggering according to any one of claims 1-7.

10. A computer-readable storage medium, wherein at least one executable instruction is stored in the storage medium, and when the executable instruction runs on a device for determining the boundary of a wireless fence based on progressive distance triggering, the device for determining the boundary of a wireless fence based on progressive distance triggering performs operations of the method for determining the boundary of a wireless fence based on progressive distance triggering according to any one of claims 1-7.
